(19) United States
(12) Patent Application Publication
(10) Pub. No.: US 2026/0162892 A1
(43) Pub. Date: Jun. 11, 2026

(54) MULTILAYER CERAMIC CAPACITOR

(71) Applicant: Murata Manufacturing Co., Ltd., Nagaokakyo-shi (JP)

(72) Inventor: Takanori FUJII, Nagaokakyo-shi (JP)

(21) Appl. No.: 19/362,556

(22) Filed: Oct. 20, 2025

(30) Foreign Application Priority Data
Dec. 6, 2024 (JP) 2024-213821

(51) Int. Cl. H01G 4/005; H01G 4/252; H01G 4/30

(52) U.S. Cl. CPC H01G 4/005; H01G 4/252; H01G 4/30

(57) ABSTRACT

A multilayer ceramic capacitor includes a multilayer body, and an outer electrode. The multilayer body includes inner and outer layer portions. The inner layer portion includes a dielectric layer and an inner electrode layer stacked in a stacking direction. The outer layer portion is located on opposite sides of the inner layer portion in the stacking direction. The outer electrode is located on each of two end surfaces, and connected to the inner electrode layer. The inner layer portion has, at an end portion in the stacking direction, a first dimension in the longitudinal direction. The inner layer portion has, at a central portion in the stacking direction, a second dimension in the longitudinal direction. The first dimension is greater than the second dimension. The outer layer portion includes an outer-layer projection that projects beyond the inner layer portion in the longitudinal direction.

### CROSS REFERENCE TO RELATED APPLICATIONS

This application claims the benefit of priority to Japanese Patent Application No. 2024-213821 filed on Dec. 6, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

A multilayer ceramic capacitor, which is one of electronic components of electronic devices, is one of the most important electronic components. With increasing functional diversification of smartphones, automobiles, and other electronic devices in recent years, there is a growing need for improved quality, in particular, improved moisture resistance of multilayer ceramic capacitor. In this regard, with multilayer ceramic capacitors according to the related art, the outer electrode is thick at the central portion in the stacking direction, and is relatively thin near the outer layer portion in the stacking direction (see, for example, Japanese Unexamined Patent Application Publication No. 2014-131009).

When the outer electrode of a multilayer ceramic capacitor is thin near the outer layer portion in the stacking direction, the multilayer ceramic capacitor has insufficient resistance against the intrusion of moisture from the surface of the outer electrode into the inner layer portion. As a result, the multilayer ceramic capacitor has reduced reliability in moisture resistance.

### SUMMARY OF THE INVENTION

Example embodiments of the present invention provide multilayer ceramic capacitors each with improved moisture resistance reliability.

A multilayer ceramic capacitor according to an example embodiment of the present invention includes a multilayer body, and an outer electrode. The multilayer body includes an inner layer portion including a dielectric layer and an inner electrode layer stacked in a stacking direction, an outer layer portion on opposite sides of the inner layer portion in the stacking direction, two major surfaces opposite to each other in the stacking direction, two side surfaces opposite to each other in a width direction intersecting with the stacking direction, and two end surfaces opposite to each other in a longitudinal direction intersecting with the stacking direction and with the width direction. The outer electrode is provided on each of the two end surfaces, and connected to the inner electrode layer. The inner layer portion has, at an end portion in the stacking direction, a dimension L1 in the longitudinal direction. The inner layer portion has, at a central portion in the stacking direction, a dimension L2 in the longitudinal direction. The dimension L1 is greater than the dimension L2. The outer layer portion includes an outer-layer projection projecting beyond the inner layer portion in the longitudinal direction. In a cross-section extending in the longitudinal direction and the stacking direction, the multilayer ceramic capacitor has, at each of the two end surfaces, a stepped shape in a vicinity of a boundary between the outer layer portion and the inner layer portion.

Example embodiments of the present invention provide multilayer ceramic capacitors each with improved moisture resistance reliability.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor 1 according to an example embodiment of the present invention.

FIG. 2 is a cross-sectional view of the multilayer ceramic capacitor 1 taken along a line II-II in FIG. 1.

FIG. 3 is a cross-sectional view of the multilayer ceramic capacitor 1 taken along a line III-III in FIG. 1.

FIG. 4 is an enlarged view of an upper left portion of FIG. 2.

FIG. 5 is a flowchart illustrating an example of a method for manufacturing a multilayer ceramic capacitor 1 according to an example embodiment of the present invention.

FIG. 6 illustrates a multilayer ceramic capacitor 100 according to a comparative configuration that corresponds to FIG. 2.

FIG. 7 is a table illustrating the verification results on the advantageous effects of the multilayer ceramic capacitor 1.

### DETAILED DESCRIPTION OF THE EXAMPLE EMBODIMENTS

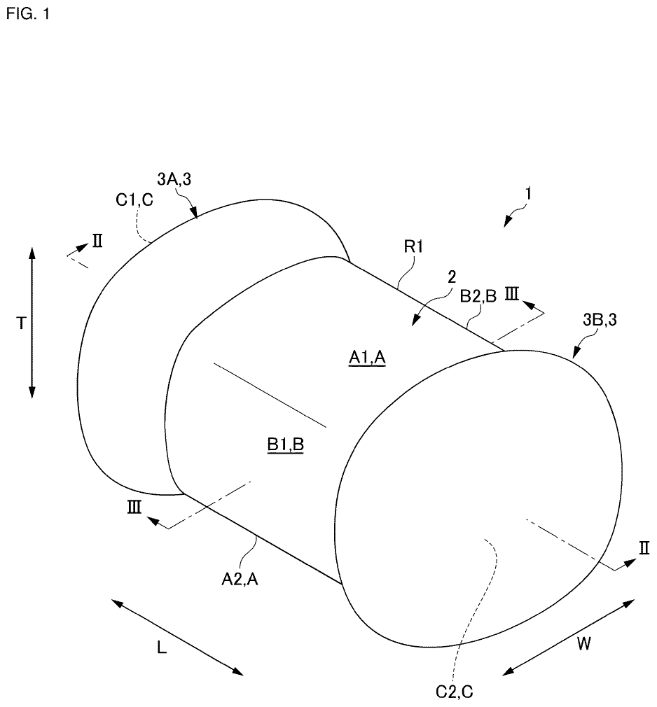

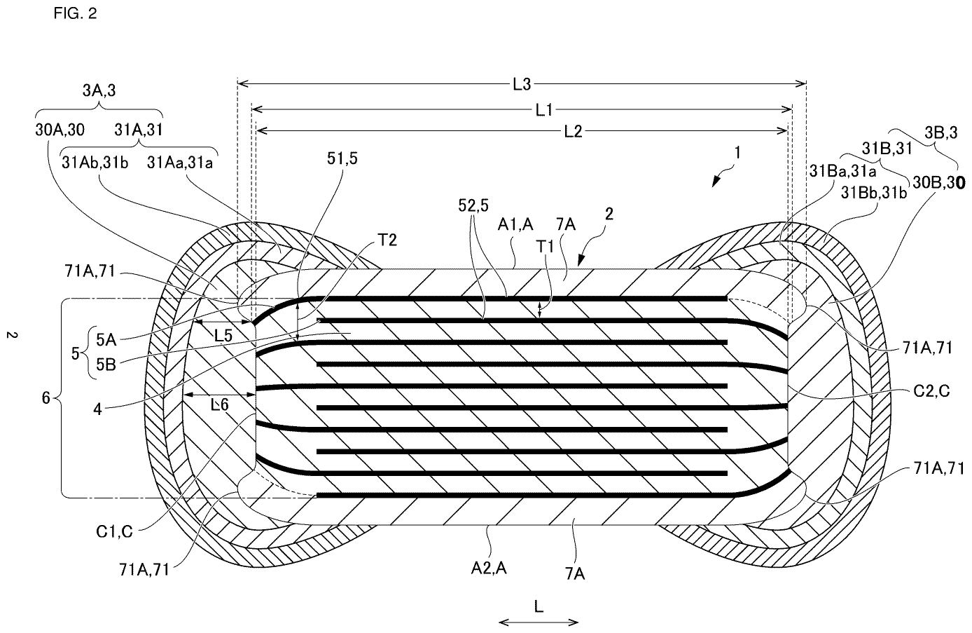

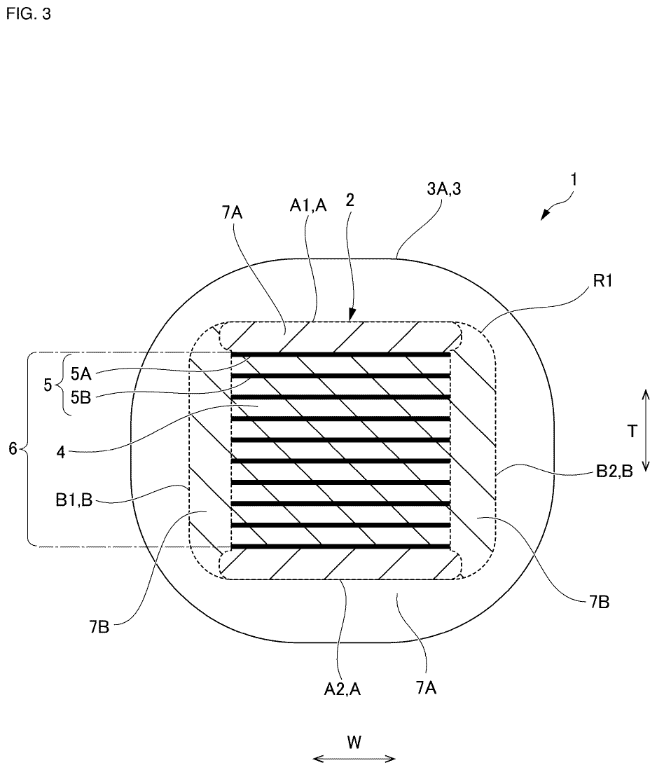

Example embodiments of the present invention will now be described with reference to the drawings. FIG. 1 is a perspective view of a multilayer ceramic capacitor 1 according to an example embodiment of the present invention. FIG. 2 is a cross-sectional view of a multilayer ceramic capacitor 1 taken along a line II-II in FIG. 1. FIG. 3 is a cross-sectional view of the multilayer ceramic capacitor 1 taken along a line III-III in FIG. 1.

The multilayer ceramic capacitor 1 includes a multilayer body 2, and a pair of outer electrodes 3 disposed at opposite ends of the multilayer body 2. The multilayer body 2 includes an inner layer portion 6. The inner layer portion 6 includes a dielectric layer 4 and an inner electrode layer 5 that are stacked alternately.

Hereinafter, terms representing directions associated with the multilayer ceramic capacitor 1 are defined as described below. A direction in which the inner electrode layer 5 and the dielectric layer 4 are stacked is defined as a stacking direction T. A direction that intersects with the stacking direction T and in which the pair of outer electrodes 3 are disposed is defined as a longitudinal direction L. A direction that intersects with both the longitudinal direction L and the stacking direction T is defined as a width direction W. According to the present example embodiment, the longitudinal direction L, the width direction W, and the stacking direction T are orthogonal or substantially orthogonal to each other.

The multilayer body 2 further includes an outer layer portion 7A disposed on opposite sides of the inner layer portion 6 in the stacking direction T, and a side gap portion 7B disposed on opposite sides of the inner layer portion 6 in the width direction W.

### Multilayer Body 2

The multilayer body 2 includes two major surfaces A that are opposite to each other in the stacking direction T, two end surfaces C that are opposite to each other in the longitudinal direction L, and two side surfaces B that are opposite to each other in the width direction W. The two major surfaces A include a first major surface A1, and a second major surface A2. The two end surfaces C include a first end surface C1, and a second end surface C2. The two side surfaces B include a first side surface B1, and a second side surface B2.

According to the present example embodiment, the multilayer body 2 is rounded at an edge portion R1 between two adjacent faces, and at a corner portion between three adjacent faces. This makes it possible to reduce the risk of chipping at angular portions of the multilayer body 2.

### Inner Layer Portion 6

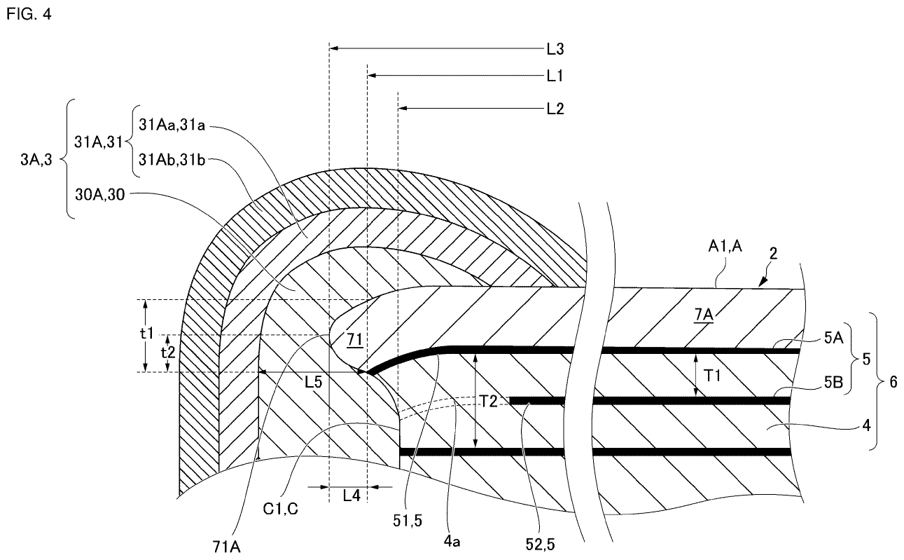

According to the present example embodiment, the inner layer portion 6 extends from the inner electrode layer 5 that is closest to the first major surface A1 to the inner electrode layer 5 that is closest to the second major surface A2. FIG. 4 is an enlarged view of an upper left portion of FIG. 2. As illustrated in FIGS. 2 and 4, the inner layer portion 6 has, at its portion closest to the major surface A in the stacking direction T, a dimension L1 in the longitudinal direction L, and has, at its central portion 6 in the stacking direction T, a dimension L2 in the longitudinal direction L. The dimension L1 is greater than the dimension L2. The dimension L1 is, for example, preferably greater than or equal to about 100.1% and less than or equal to about 102% of the dimension L2.

### Dielectric Layer 4

In one non-limiting example, the dielectric layer 4 may include major components such as barium titanate, and minor components such as Mg or Mn.

### Inner Electrode Layer 5

The inner electrode layer 5 includes a first inner electrode layer 5A exposed at the first end surface C1, and a second inner electrode layer 5B exposed at the second end surface C2.

As illustrated in FIG. 2, the inner electrode layer 5 includes an opposed portion 52 where the first inner electrode layer 5A and the second inner electrode layer 5B are opposed to each other, and an extended portion 51 where the first inner electrode layer 5A and the second inner electrode layer 5B are not opposed to each other. The extended portion 51 extends from the opposed portion 52 toward one of the first end surface C1 and the second end surface C2. The direction in which the extended portion 51 extends differs between the first inner electrode layer 5A and the second inner electrode layer 5B. That is, the extended portion 51 extends alternately toward the first end surface C1 and toward the second end surface C2. The extended portion 51 of the first inner electrode layer 5A is, at its end portion, exposed at the first end surface C1, and electrically connected to a first outer electrode 3A. The extended portion 51 of the second inner electrode layer 5B is, at its end portion, exposed at the second end surface C2, and electrically connected to a second outer electrode 3B. That is, the dielectric layer 4 in which the first inner electrode layer 5A exposed at the first end surface C1 is disposed, and the second inner electrode layer 5B in which the second inner electrode layer 5B exposed at the second end surface C2 is disposed are stacked alternately. The first inner electrode layer 5A and the second inner electrode layer 5B that are adjacent to each other in the stacking direction T store charge between their respective opposed parts 52, and thus define and function as a capacitor.

$$T 2 > 2 \times T 1$$

As illustrated in FIGS. 2 and 4, according to the present example embodiment, the relationship T2>2×T1 is satisfied, where T1 is the dimension in the stacking direction T, at the central portion in the longitudinal direction L of the multilayer body 2, between the opposed portion 52 of the first inner electrode layer 5A, and the opposed portion 52 of the second inner electrode layer 5B adjacent to the first inner electrode layer 5A, and T2 is the dimension in the stacking direction T, at a location near the first end surface in the longitudinal direction L of the multilayer body 2, between the extended portion 51 of the first inner electrode layer 5A, and the extended portion 51 of the first inner electrode layer 5A adjacent to the extended portion 51 of the above-mentioned first inner electrode layer 5A.

### Outer Layer Portion 7A

The outer layer portion 7A is disposed on opposite sides of the inner layer portion 6 in the stacking direction T, that is, on a side of the inner layer portion 6 near the first major surface A1 and on a side of the inner layer portion 6 near the second major surface A2. The outer layer portion 7A is, for example, preferably made mainly of materials such as barium titanate or calcium zirconate, and preferably includes additives such as Si, V, Mn, Mg, or Ni.

### Outer-Layer Projection 71

The outer layer portion 7A includes an outer-layer projection 71 that projects beyond the inner layer portion 6 in the longitudinal direction L. The outer-layer projection 71 is located closer to the inner layer portion 6 than is the first major surface A1 or the second major surface A2. The outer-layer projection 71 includes a maximum outer-layer projection 71A where the outer-layer projection 71 has the maximum dimension in the longitudinal direction L.

According to the present example embodiment, in a cross-section extending in the longitudinal direction L and the stacking direction, the multilayer ceramic capacitor 1 has, at the end surface C, a stepped shape in the vicinity of the boundary between the outer layer portion 7A and the inner layer portion 6. A stepped shape refers to a shape such that, as illustrated in FIG. 4, a distance t2 of the maximum outer-layer projection 71A from the inner layer portion 6 in the stacking direction T is, for example, less than or equal to about 70% of a maximum dimension t1 of the outer-layer projection 71 in the stacking direction T. According to the present example embodiment, the dimension t1 of the outer layer portion 7A in the stacking direction T is constant of substantially constant except at the location of the outer-layer projection 71.

The distance in the longitudinal direction L from the inner layer portion 6 to the maximum outer-layer projection 71A, that is, an amount of projection L4 of the outer-layer projection 71 is, for example, preferably greater than or equal to about 1.50 μm and less than or equal to about 15.00 μm, and more preferably greater than or equal to about 3.00 μm and less than or equal to about 10.00 μm.

As will be described later in detail, an amount of projection L4 less than about 1.50 μm makes it impossible to provide a sufficiently thick outer electrode 3, which results in moisture intrusion and an inability to provide favorable moisture resistance. An amount of projection L4 greater than or equal to about 1.50 μm results in improved moisture resistance, and an amount of projection L4 greater than or equal to about 3.00 μm makes it possible to provide further improved moisture resistance to achieve improved moisture resistance.

During sintering, residual stress that develops between the outer layer portion 7A and the inner layer portion 6 can cause structural defects to occur between the outer layer portion 7A and the inner layer portion 6. In this regard, an amount of projection L4 less than or equal to about 15.00 μm allows the rate of occurrence of such structural defects to be within tolerance. Further, an amount of projection L4 less than or equal to about 10 μm further reduces a potential occurrence of such structural defects.

The presence of the outer-layer projection 71 can be restated as follows. A maximum dimension L3 in the longitudinal direction L of the outer layer portion 7A is greater than the maximum dimension L1 in the longitudinal direction L of the inner layer portion 6. The inner layer portion 6 has a smaller dimension in the longitudinal direction L than the outer layer portion 7A. The outer layer portion 7A is extended beyond the inner electrode layer 5 in the longitudinal direction L.

### Side Gap Portion 7B

The side gap portion 7B is disposed on a side of the inner layer portion 6 near the first side surface B1 of the multilayer body 2, and on a side of the inner layer portion 6 near the second side surface B2 of the multilayer body 2. The side gap portion 7B may include a single layer, or may include two or more layers including an inner layer closest to the inner layer portion 6 and an outer layer closest to the side surface.

According to the present example embodiment, the side gap portion 7B is produced from a material the same as or similar to that of the dielectric layer 4. Alternatively, however, the side gap portion 7B may be different in material and composition from the dielectric layer 4. The thickness of the side gap portion is, for example, preferably greater than or equal to about 1 μm and less than or equal to about 50 μm.

Although not illustrated, the side gap portion 7B and the inner layer portion 6 have the same or substantially the same dimension in the longitudinal direction L, and the outer layer portion 7A projects beyond the side gap portion 7B and the inner layer portion 6 in the longitudinal direction L. In other words, the outer layer portion 7A has a dimension in the longitudinal direction L greater than the dimension in the longitudinal direction L of each of the inner layer portion 6 and the side gap portion 7B, and the side gap portion 7B and the inner layer portion 6 have the same or substantially the same dimension in the longitudinal direction L. As illustrated in FIG. 3, an end portion in the width direction W of the inner electrode layer 5 has relatively little positional variations in the width direction W, and the amount of misalignment in the width direction W is, for example, greater than or equal to about 0.1 μm and less than or equal to about 1 μm. This results in favorable electrical characteristics.

### Outer Electrode 3

The outer electrode 3 includes the first outer electrode 3A, and the second outer electrode 3B. The outer electrode 3 is connected to the inner electrode layer 5. The first outer electrode 3A is disposed at the first end surface C1, and further extends to the first major surface A1, the second major surface A2, the first side surface B1, and the second side surface B2. The second outer electrode 3B is disposed at the second end surface C2, and further extends to the first major surface A1, the second major surface A2, the first side surface B1, and the second side surface B2.

### First Outer Electrode 3A

The first outer electrode 3A includes a first base electrode layer 30A, and a first plating layer 31A. The first base electrode layer 30A is connected to the first inner electrode layer 5A. The first base electrode layer 30A is disposed on the first end surface C1, and at the first major surface A1, the second major surface A2, the first side surface B1, and the second side surface B2.

The first plating layer 31A includes, for example, a first Ni plating layer 31Aa disposed on the first base electrode layer 30A, and a first Sn plating layer 31Ab disposed on the first Ni plating layer 31Aa.

### Second Outer Electrode 3B

The second outer electrode 3B includes a second base electrode layer 30B, and a second plating layer 31B. The second base electrode layer 30B is connected to the second inner electrode layer 5B. The second base electrode layer 30B is disposed on the second end surface C2, and at the first major surface A1, the second major surface A2, the first side surface B1, and the second side surface B2.

The second plating layer 31B includes, for example, a second Ni plating layer 31Ba disposed on the second base electrode layer 30B, and a second Sn plating layer 31Bb disposed on the second Ni plating layer 31Ba.

Hereinafter, the first outer electrode 3A and the second outer electrode 3B will be collectively referred to as the outer electrode 3 when there is no need to distinguish therebetween. The first base electrode layer 30A and the second base electrode layer 30B will be collectively referred to as a base electrode layer 30 when there is no need to distinguish therebetween. The first plating layer 31A and the second plating layer 31B will be collectively referred to as a plating layer 31 when there is no need to distinguish therebetween. The first Ni plating layer 31Aa and the second Ni plating layer 31Ba will be collectively referred to as a Ni plating layer 31a when there is no need to distinguish therebetween. The first Sn plating layer 31Ab and the second Sn plating layer 31Bb will be collectively referred to as a Sn plating layer 31b when there is no need to distinguish therebetween.

### Base Electrode Layer 30

The base electrode layer 30 includes a metallic component and a glass component, or a metallic component and a ceramic component. According to the present example embodiment, the base electrode layer 30 includes Cu as a metallic component. The base electrode layer 30 has a maximum thickness (a dimension in the longitudinal direction L) of, for example, greater than or equal to about 5 μm and less than or equal to about 40 μm.

As illustrated in FIG. 2, in the cross-section taken at the central portion in the width direction W and extending in the longitudinal direction L and the stacking direction T, the base electrode layer 30 has a thickness (a dimension in the longitudinal direction L) L6 at the central portion in the stacking direction T of the inner layer portion 6, and has a thickness (a dimension in the longitudinal direction L) L5 at an end portion in the stacking direction T of the inner layer portion 6. According to the present example embodiment, the dimension L5 is, for example, preferably greater than or equal to about 65% and less than or equal to about 95% of the dimension L6, and more preferably greater than or equal to about 70% and less than or equal to about 90% of the dimension L6.

With regard to the thickness of the base electrode layer 30, a dimension L5 less than about 65% of the dimension L6 may make it impossible to completely block the intrusion of moisture from the outer face of the outer electrode 3 into the inner layer portion 6. In contrast, a dimension L5 greater than or equal to about 65% of the dimension L6 makes it possible to ensure that the outer electrode 3 has a sufficient thickness across the entire region, which in turn makes it possible to block the intrusion of moisture from the outer face of the outer electrode 3 into the inner layer portion 6. Further, a dimension L5 greater than or equal to about 70% of the dimension L6 makes it possible to completely block moisture intrusion.

An excessively large dimension L5 relative to the dimension L6 results in an excessively large amount of projection L4, which may lead to an increased residual stress that develops between the outer layer portion 7A and the inner layer portion 6 during sintering. This can cause structural defects to occur between the outer layer portion 7A and the inner layer portion 6. When, however, the dimension L5 is less than or equal to about 95% of the dimension L6, this still allows structural defects to occur but such structural defects are within tolerance. When the dimension L5 is less than or equal to about 90% of the dimension L6, this further reduces the risk of occurrence of such structural defects.

Thus, it is understood from the foregoing that a dimension L5 within a preferable range, that is, for example, greater than or equal to about 65% and less than or equal to about 95% of the dimension L6, makes it possible to achieve both improved moisture resistance and a reduced occurrence of structural defects, and a dimension L5 within a more preferable range, that is, for example, greater than or equal to about 70% and less than or equal to about 90% of the dimension L6, makes it possible to achieve both improved moisture resistance and a reduced occurrence of structural defects in a more favorable manner.

### Plating Layer 31

The Ni plating layer 31a is capable of preventing the base electrode layer 30 from being corroded by solder in mounting the ceramic electronic component. The Sn plating layer 31b enables improved wettability of solder in mounting the multilayer ceramic capacitor 1. The plating layer 31 need not necessarily include two layers but may include a single layer or three or more layers.

### Method for Manufacturing Multilayer Ceramic Capacitor 1

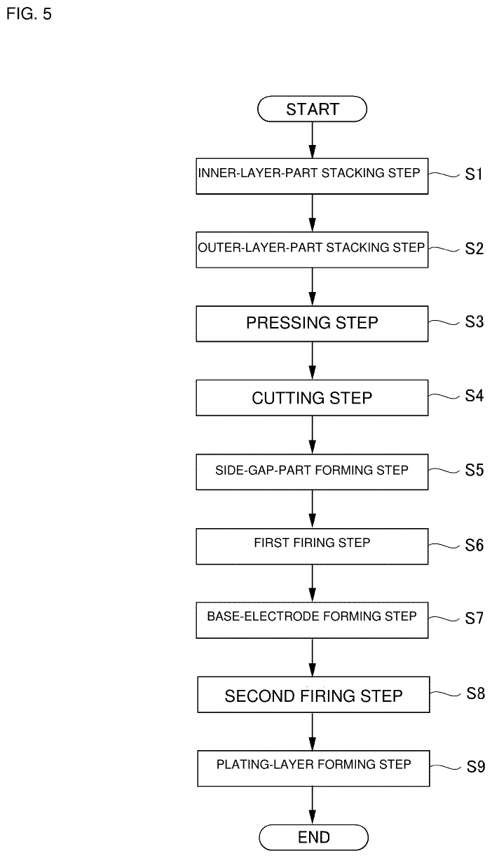

An example of a method for manufacturing the multilayer ceramic capacitor 1 according an example embodiment of the present invention will now be described. FIG. 5 is a flowchart illustrating an example of a method for manufacturing the multilayer ceramic capacitor 1 according to the present example embodiment.

### Inner-Layer-Portion Stacking Step S1

First, a ceramic slurry is formed into sheet form to prepare an inner-layer-portion ceramic green sheet, which is a ceramic green sheet used for forming the inner layer portion. The ceramic slurry includes, for example, major components such as barium titanate, minor components such as Mg or Mn, and organic components of organic compounds. A conductive paste is applied onto the inner-layer-portion ceramic green sheet to form a base sheet with a pattern for the inner electrode layer 5 printed thereon. Then, a plurality of such base sheets are stacked such that patterns for the inner electrode layers 5 are offset by about half a pitch in the longitudinal direction L between adjacent base sheets.

$$T 2 > 2 \times T 1$$

At this time, portions of the inner electrode layers 5 that will become the opposed portion 52 are stacked successively in the stacking direction T. As for portions of the inner electrode layers 5 that will become the extended portion 51, a portion of the inner-layer-portion ceramic green sheet where the inner electrode layer 5 exists, and a portion of the inner-layer-portion ceramic green sheet where the inner electrode layer 5 does not exist are stacked alternately. Therefore, the number of the inner electrode layers 5 stacked in the stacking direction T in the portions that will become the extended portion 51 is about half the number of the inner electrode layers 5 stacked in the stacking direction T in the portions that will become the opposed portion 52.

In this regard, according to the present example embodiment, a paste 4a, which has the same composition as the inner-layer-portion ceramic green sheets, is applied to regions of the inner-layer-portion ceramic green sheets where the inner electrode layer 5 does not exist. As a result, when the multilayer ceramic capacitor 1 is manufactured as illustrated in FIG. 4, the presence of the paste 4a makes it possible to compensate for the reduced thickness due to the decreased number of the inner electrode layers 5 in the portions where the extended portion 51 is located.

As a result, as described above, the relationship T2>2×T1 is satisfied, where T1 is the dimension in the stacking direction T, at the central portion in the longitudinal direction L of the multilayer body 2, between the opposed portion 52 of the first inner electrode layer 5A, and the opposed portion 52 of the second inner electrode layer 5B adjacent to the first inner electrode layer 5A, and T2 is the dimension in the stacking direction T, at a location near the first end surface in the longitudinal direction L of the multilayer body 2, between the extended portion 51 of the first inner electrode layer 5A, and the extended portion 51 of the first inner electrode layer 5A adjacent to the extended portion 51 of the first inner electrode layer 5A.

Now, a case is considered where, unlike as in the present example embodiment, the paste 4a is not applied to compensate for the absence of thickness corresponding to the inner electrode layer 5 at the location where no inner electrode layer 5 exists. In this case, the region that will become the extended portion 51 has a thickness in the stacking direction T that decreases with increasing proximity to the end surface C relative to the region that will become the opposed portion 52, and thus has increasing deflection with increasing proximity to the end surface C. If the degree of such deflection is pronounced, this may cause deterioration of the electrical characteristics of the multilayer ceramic capacitor, such as electrical resistance.

However, according to the present example embodiment, the relationship T2>2×T1 is satisfied, and thus the region corresponding to the extended portion 51 is configured in a manner that minimizes such deflection. This helps to reduce the risk of deterioration of the electrical characteristics of the multilayer ceramic capacitor, such as electrical resistance.

Further, since the region corresponding to the extended portion 51 is configured in a manner that minimizes its deflection, the degree of deflection of the outer layer portion 7A is also reduced. This makes it easier to ensure that the base electrode layer 30 has a sufficient thickness L5 at an end portion in the stacking direction T of the inner layer portion 6. Therefore, improved reliability in moisture resistance can be provided by the combination of the following features: the presence of the outer-layer projection 71 and the resulting stepped shape, and the low degree of deflection at a corner portion of the multilayer body 2 where the longitudinal direction L and the stacking direction T intersect with each other.

### Outer-Layer-Portion Stacking Step S2

An outer-layer-portion ceramic green sheet, which is a ceramic green sheet that will become the outer layer portion 7A, is stacked on each side of the stack of base sheets to thus define a mother block. According to the present example embodiment, as with the inner-layer-portion ceramic green sheet, in one non-limiting example, the outer-layer-portion ceramic green sheet may include, for example, major components such as barium titanate or calcium zirconate, minor components such as Mg or Mn, and organic components of organic compounds. However, the content of the major components of the outer-layer-portion ceramic green sheet is greater than the content of the major components of the inner-layer-portion ceramic green sheet. The content of the organic components of the outer-layer-portion ceramic green sheet is less than the content of the organic components of the inner-layer-portion ceramic green sheet.

### Pressing Step S3

Subsequently, the mother block is pressed to bond the layers together with heat and pressure. The pressing may be rigid pressing or may be isostatic pressing, for example.

### Cutting Step S4

The mother block is cut along cutting lines to produce a cuboid multilayer chip. At this time, the inner electrode layers 5 are exposed at opposite ends in the width direction W, and the end portions in the width direction W of the inner electrode layers 5 are aligned in the width direction W.

### Side-Gap-Portion Forming Step S5

Subsequently, a side-gap-portion ceramic green sheet is producing by using a material the same or similar to the material of the inner-layer-portion ceramic green sheet, with a ratio of organic to inorganic components equal or substantially equal to the corresponding ratio of the inner-layer-portion ceramic green sheet. The side-gap-portion ceramic green sheet is bonded to each side surface of the multilayer chip. The multilayer chip with the side-gap-portion ceramic green sheet attached thereto is also cuboid in shape.

### First Firing Step S6

The multilayer chip with the side-gap-portion ceramic green sheet attached thereto is fired at a predetermined temperature to form the multilayer body 2. In this regard, the outer-layer-portion ceramic green sheet has a higher content of inorganic components than the inner-layer-portion ceramic green sheet. Therefore, the outer layer portion 7A undergoes less shrinkage upon firing than the inner layer portion 6. This results in formation, in the outer layer portion 7A, of the outer-layer projection 71 that projects beyond the inner layer portion 6.

As illustrated in FIG. 3, in the cross-section extending in the width direction W and the stacking direction T as well, the outer layer portion 7A projects slightly beyond the inner layer portion 6 after sintering. However, since the side gap portion 7B disposed outside the outer layer portion 7A in the width direction W undergoes more shrinkage than the outer layer portion 7A, the amount of projection of the outer layer portion 7A is canceled out by the shrinkage of the side gap portion 7B. The shape of the multilayer body 2 thus remains rectangular or substantially rectangular in the cross-section extending in the width direction W and the stacking direction T.

### Base-Electrode-Layer Forming Step S7

Subsequently, through the dipping process on the multilayer body 2, a base-electrode-layer paste, which includes a conductive metal and glass and will become the outer electrode 3, is deposited onto the end surface C of the multilayer body 2. The base-electrode-layer paste is also applied onto the first major surface A1, the second major surface A2, the first side surface B1, and the second side surface B2 of the multilayer body 2. At this time, due to surface tension, the base-electrode-layer 30 paste does not take on a shape that follows the abrupt change in shape at the corner portion of the multilayer body 2 and, as a result, forms a generally rounded shape that covers the outer-layer projection 71.

### Second Firing Step S8

Subsequently, the multilayer body 2 with the base-electrode-layer paste deposited thereon is fired again at a predetermined temperature. The base electrode layer 30 is thus formed on the multilayer body 2.

### Plating-Layer Forming Step S9

Subsequently, for example, first, the Ni plating layer 31a is formed on the periphery of the base electrode layer 30 so as to cover the base electrode layer 30. The Sn plating layer 31b is then formed on the periphery of the Ni plating layer 31a so as to cover the Ni plating layer 31a.

Through the steps described above, the multilayer ceramic capacitor 1 according to the present example embodiment is manufactured. The multilayer ceramic capacitor 1 according to the present example embodiment has advantageous effects described below.

### Advantageous Effects of Presence of Outer-Layer Projection 71

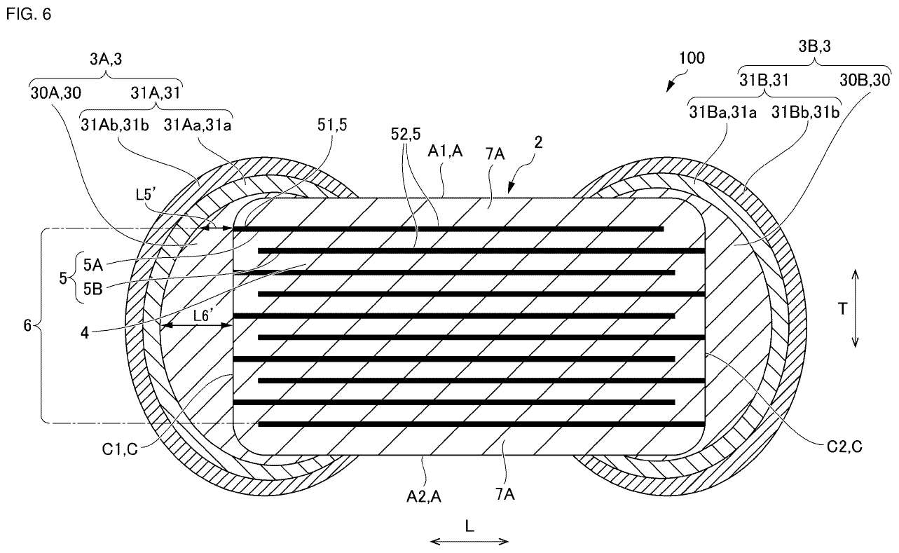

FIG. 6 illustrates a multilayer ceramic capacitor 100 according to a comparative configuration that corresponds to FIG. 2. In FIG. 6, features the same as or similar to those in FIG. 2 are designated by the same reference signs. The multilayer ceramic capacitor 100 according to the comparative configuration differs from the multilayer ceramic capacitor 1 according to the example embodiment in that the outer layer portion 7A does not include the outer-layer projection 71 that projects beyond the inner layer portion 6 in the longitudinal direction L.

As described above, in applying the base-electrode-layer paste, due to surface tension, the base-electrode-layer paste does not take on a shape that follows the abrupt change in shape at the corner portion of the multilayer body 2, and takes on a generally rounded shape at the corner portion. Consequently, according to the comparative configuration, as illustrated in FIG. 6, the base electrode layer 30 has a sufficient thickness L6′ at the central portion in the stacking direction T, whereas the base electrode layer 30 has, at an end portion in the stacking direction T of the inner layer portion 6, a thickness L5′ that is considerably less than that according to the present example embodiment. Therefore, at an end portion in the stacking direction T of the inner layer portion 6, the distance from the surface of the outer electrode 3 to the inner electrode layer 5 becomes comparatively short. This results in an increased risk of moisture intrusion, which in turn makes it impossible to provide satisfactory moisture resistance reliability.

In contrast, according to the present example embodiment, the outer layer portion 7A includes the outer-layer projection 71 that projects beyond the inner layer portion 6 in the longitudinal direction L as illustrated in FIGS. 2 and 4. Thus, in the cross-section taken at the central portion in the width direction W and extending in the longitudinal direction L and the stacking direction T, the difference between the thickness L6 of the base electrode layer 30 at the central portion in the stacking direction T, and the thickness L5 of the base electrode layer 30 at an end portion in the stacking direction T of the inner layer portion 6 is less than that according to the comparative configuration. This results in a longer path of moisture intrusion from the surface of the outer electrode 3 to the inner electrode layer 5, which reduces the risk of moisture intrusion and improves the moisture resistance reliability of the multilayer ceramic capacitor 1.

### Verification Results on Advantageous Effects of Multilayer Ceramic Capacitor 1

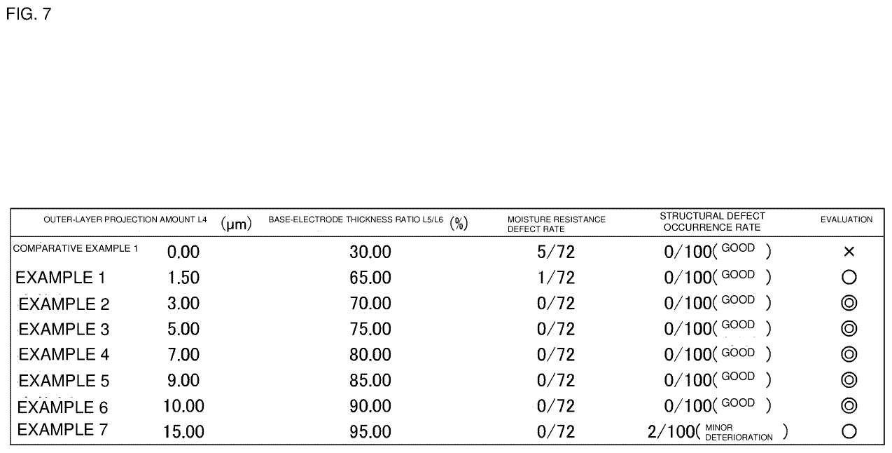

The results of an experiment conducted to verify the advantageous effects of the multilayer ceramic capacitor 1 according to the present example embodiment will now be described. FIG. 7 is a table illustrating the verification results on the advantageous effects of the multilayer ceramic capacitor 1.

First, the multilayer ceramic capacitors 1 according to Examples 1 to 7, which are made to differ in the amount of projection L4 of the outer-layer projection 71 by varying the ratio between the inorganic and organic components contained in the outer layer portion 7A, and the multilayer ceramic capacitor 100 according to Comparative Example with no projecting outer layer portion are produced.

As for the multilayer ceramic capacitor 100 according to Comparative Example, the inner-layer-portion ceramic green sheet and the outer-layer-portion ceramic green sheet are made to have the same or substantially the same ratio between the organic and inorganic components so that their rates of shrinkage before and after firing are the same or substantially the same.

The multilayer ceramic capacitor 1 according to the present example embodiment and the multilayer ceramic capacitor 100 according to the comparative configuration both have a dimension of about 3.2 mm in the longitudinal direction L, a dimension of about 2.5 mm in the width direction W, and a dimension of about 2.5 mm in the stacking direction T.

### Amount of Projection L4

Each multilayer ceramic capacitor is ground from its side surface to expose a cross-section taken at the central portion in the width direction W and extending in the longitudinal direction L and the stacking direction T. The cross-section is observed with an optical microscope, and the amount of projection L4, which is the distance between the inner layer portion 6 and the maximum outer-layer projection 71A in the longitudinal direction L, is measured. At this time, a portion of the inner layer portion 6 that is in contact with the outer layer portion 7A is used as the reference position for the measurement.

### L5/L6

Further, the thickness (the dimension in the longitudinal direction L) L6 of the base electrode layer 30 at the central portion in the stacking direction T of the inner layer portion 6, and the thickness (the dimension in the longitudinal direction L) L5 of the base electrode layer 30 at an end portion in the stacking direction T of the inner layer portion 6 are measured. Further, the ratio of the dimension L5 to the dimension L6 ((L5/L6)×100) is calculated.

With Example 1, the amount of projection L4 is about 1.50 μm, and the ratio of the dimension L5 to the dimension L6 is about 65%. With Example 2, the amount of projection L4 is about 3.00 μm, and the ratio of the dimension L5 to the dimension L6 is about 70%. With Example 3, the amount of projection L4 is about 5.00 μm, and the ratio of the dimension L5 to the dimension L6 is about 75%. With Example 4, the amount of projection L4 is about 7.00 μm, and the ratio of the dimension L5 to the dimension L6 is about 80%. With Example 5, the amount of projection L4 is about 9.00 μm, and the ratio of the dimension L5 to the dimension L6 is about 85%. With Example 6, the amount of projection L4 is about 10.00 μm, and the ratio of the dimension L5 to the dimension L6 is about 90%. With Example 7, the amount of projection L4 is about 11.00 μm, and the ratio of the dimension L5 to the dimension L6 is about 95%. With Comparative Example 1, the amount of projection L4 is about 0.00 μm, and the ratio of the dimension L5 to the dimension L6 is about 30%.

### Moisture Resistance Test (n=72)

(1) The multilayer ceramic capacitors described above are mounted onto a circuit board, and under the condition of a moisture resistance degree of about 85% and a temperature of about 85° C., a voltage of about 2.5 V is applied for about 2000 hours to the substrate with the multilayer ceramic capacitors mounted thereon.
(2) Subsequently, the respective insulation resistances of these multilayer ceramic capacitors are measured at room temperature under the condition of a test voltage of about 10 V and an application duration of about 60 seconds, and multilayer ceramic capacitors with an insulation resistance less than or equal to about 0.114 MΩ are counted as samples defective in moisture resistance. Then, a moisture-resistance defective rate, which is a defective rate in terms of moisture resistance, is determined.

As a result, with Comparative Example 1, the moisture-resistance defective rate is 5/72 as illustrated in FIG. 7. With Example 1, the moisture-resistance defective rate is 1/72. With Examples 2 to 7, the moisture-resistance defective rate is 0/72.

It has been verified from the foregoing that Examples 1 to 7, in which the amount of projection L4 is greater than or equal to about 1.50 μm and the ratio of the dimension L5 to the dimension L6 is greater than or equal to about 65%, has favorable moisture resistance as compared with Comparative Example 1. It has been further verified that Examples 2 to 7, in which the amount of projection L4 is about 3.00 μm and the ratio of the dimension L5 to the dimension L6 is greater than or equal to about 70%, has further improved moisture resistance.

### Internal Structural Defect Test (n=100)

Each multilayer ceramic capacitor is ground from its side surface to expose a cross-section at the central portion in the width direction W and extending in the longitudinal direction L and the stacking direction T. The cross-section is checked with an optical microscope for the presence or absence of cracks between the inner layer portion 6 and the outer layer portion 7A, and the number of samples with cracks is counted to determine a structural-defect occurrence rate.

As illustrated in FIG. 7, with Comparative Example 1, the structural-defect occurrence rate is 0 out of 100 samples. With Examples 1 to 6, the structural-defect occurrence rate is 0 out of 100 samples. With Example 7, the structural-defect occurrence rate is 2 out of 100 samples, which represents a slight increase but is still within tolerances.

It has been verified from the foregoing that with Examples 1 to 7, the structural-defect occurrence rate is within tolerances. It has been also verified that when the amount of projection L4 is about 15.00 μm, that is, when the dimension L5 is about 95% of the dimension L6, slight occurrences of structural defects are observed between the outer layer portion 7A and the inner layer portion 6 due to the residual stress that develops between the outer layer portion 7A and the inner layer portion 6 upon sintering, but such structural defects are within tolerances. Further, it has been verified that when the amount of projection L4 is less than or equal to about 10 μm, that is, when the dimension L5 is less than or equal to about 90% of the dimension L6, the structural-defect occurrence rate is 0 out of 100 samples, and thus the risk of structural defect occurrence is further reduced.

It has been thus verified that, for example, from the viewpoint of achieving both moisture resistance reliability and a reduction of structural defects, preferably, the amount of projection L4 is greater than or equal to about 1.50 μm and less than or equal to about 15.00 μm (the dimension L5 is greater than or equal to about 65% and less than or equal to about 95% of the dimension L6), and more preferably, the amount of projection L4 is greater than or equal to about 3.00 μm and less than or equal to about 10.00 μm (the dimension L5 is greater than or equal to about 70% and less than or equal to about 90% of the dimension L6).

Although example embodiments of the present invention have been described above, the present invention is not limited to the example embodiments, and variations and modifications are possible. For example, the dielectric layer, the outer layer portion, or the side gap portion may include calcium zirconate or other compounds as its major components, and may include elements other than Mg or Mn as its minor components. Further, for example, as described above, the side gap portion 7B may include a single layer, or may include two or more layers including an inner layer closest to the inner layer portion 6 and an outer layer closest to the side surface. The plating layer 31 need not necessarily include two layers, and may include a single layer, or three or more layers.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including:
an inner layer portion including a dielectric layer and an inner electrode layer stacked in a stacking direction;
an outer layer portion opposite sides of the inner layer portion in the stacking direction;
two major surfaces opposite to each other in the stacking direction;
two side surfaces opposite to each other in a width direction intersecting with the stacking direction;
two end surfaces opposite to each other in a longitudinal direction intersecting with the stacking direction and with the width direction; and
an outer electrode on each of the two end surfaces and connected to the inner electrode layer; wherein
the inner layer portion has, at an end portion in the stacking direction, a dimension L1 in the longitudinal direction;
the inner layer portion has, at a central portion in the stacking direction, a dimension L2 in the longitudinal direction;
the dimension L1 is greater than the dimension L2;
the outer layer portion includes an outer-layer projection projecting beyond the inner layer portion in the longitudinal direction; and
in a cross-section extending in the longitudinal direction and the stacking direction, the multilayer ceramic capacitor has, at each of the two end surfaces, a stepped shape in a vicinity of a boundary between the outer layer portion and the inner layer portion.

2. The multilayer ceramic capacitor according to claim 1, wherein
the outer-layer projection includes a maximum outer-layer projection where the outer-layer projection projects farthest in the longitudinal direction; and
a distance L4 from the inner layer portion to the maximum outer-layer projection is greater than or equal to about 1.50 μm and less than or equal to about 15.00 μm.

3. The multilayer ceramic capacitor according to claim 1, wherein
the outer electrode includes:
a base electrode on each of the two end surfaces; and
a plating layer outside the base electrode; and
in the cross-section extending in the longitudinal direction and the stacking direction, the base electrode has, at the end portion in the stacking direction of the inner layer portion, a dimension L5 in the longitudinal direction, and, at the central portion in the stacking direction of the inner layer portion, a dimension L6 in the longitudinal direction; and
the dimension L5 is greater than or equal to about 65% and less than or equal to about 95% of the dimension L6.

4. The multilayer ceramic capacitor according to claim 1, wherein
the two end surfaces include a first end surface and a second end surface;
the inner electrode layer includes a first inner electrode layer extending to the first end surface, and a second inner electrode layer extending to the second end surface;
the first inner electrode layer includes a first opposed portion opposed to the second inner electrode layer, and a first extended portion not opposed to the second inner electrode layer;
the second inner electrode layer includes a second opposed portion opposed to the first inner electrode layer, and a second extended portion not opposed to the first inner electrode layer; and
a relationship T2>2×T1 is satisfied, where:
T1 is a dimension in the stacking direction, at a central portion in the longitudinal direction of the multilayer body, of the dielectric layer between the first inner electrode layer and the second inner electrode layer; and
T2 is a dimension in the stacking direction, at the first end surface, between first extended portions adjacent to each other.

5. The multilayer ceramic capacitor according to claim 1, wherein an amount of misalignment of an end portion in the width direction of the inner electrode layer in the width direction is greater than or equal to about 0.1 μm and less than or equal to about 1 μm.

6. The multilayer ceramic capacitor according to claim 1, wherein, in the stacking direction, the outer-layer projection is located closer to the inner layer portion than each of the two major surfaces.

7. The multilayer ceramic capacitor according to claim 1, wherein the dimension L1 is greater than or equal to about 100.1% and less than or equal to about 102% of the dimension L2.

8. The multilayer ceramic capacitor according to claim 2, wherein the distance L4 from the inner layer portion to the maximum outer-layer projection is greater than or equal to about 3.00 μm and less than or equal to about 10.00 μm.

9. The multilayer ceramic capacitor according to claim 3, wherein the dimension L5 is greater than or equal to about 70% and less than or equal to about 90% of the dimension L6.

10. The multilayer ceramic capacitor according to claim 5, wherein
the multilayer body includes a side gap portion on opposite sides of each of the inner layer portion and the outer layer portion in the width direction; and
the outer layer portion projects beyond the side gap portion in the longitudinal direction.

11. The multilayer ceramic capacitor according to claim 5, wherein
the two end surfaces include a first end surface and a second end surface;
the inner electrode layer includes a first inner electrode layer extending to the first end surface, and a second inner electrode layer extending to the second end surface;
the first inner electrode layer includes a first opposed portion opposed to the second inner electrode layer, and a first extended portion not opposed to the second inner electrode layer;
the second inner electrode layer includes a second opposed portion opposed to the first inner electrode layer, and a second extended portion not opposed to the first inner electrode layer; and
a relationship T2>2×T1 is satisfied, where:
T1 is a dimension in the stacking direction, at a central portion in the longitudinal direction of the multilayer body, of the dielectric layer between the first inner electrode layer and the second inner electrode layer; and
T2 is a dimension in the stacking direction, at the first end surface, between first extended portions adjacent to each other.

12. The multilayer ceramic capacitor according to claim 5, wherein
the outer-layer projection includes a maximum outer-layer projection where the outer-layer projection projects farthest in the longitudinal direction; and
a distance L4 from the inner layer portion to the maximum outer-layer projection is greater than or equal to about 1.50 μm and less than or equal to about 15.00 μm.

13. The multilayer ceramic capacitor according to claim 5, wherein
the outer electrode includes:
a base electrode on each of the two end surfaces; and
a plating layer outside the base electrode; and
in the cross-section extending in the longitudinal direction and the stacking direction, the base electrode has, at the end portion in the stacking direction of the inner layer portion, a dimension L5 in the longitudinal direction, and, at the central portion in the stacking direction of the inner layer portion, a dimension L6 in the longitudinal direction; and
the dimension L6 is greater than the dimension L5.

14. The multilayer ceramic capacitor according to claim 5, wherein, in the stacking direction, the outer-layer projection is located closer to the inner layer portion than each of the two major surfaces.

15. The multilayer ceramic capacitor according to claim 4, wherein
the outer-layer projection includes a maximum outer-layer projection where the outer-layer projection projects farthest in the longitudinal direction; and
a distance L4 from the inner layer portion to the maximum outer-layer projection is greater than or equal to about 1.50 μm and less than or equal to about 15.00 μm.

16. The multilayer ceramic capacitor according to claim 4, wherein
the outer electrode includes:
a base electrode on each of the two end surfaces; and
a plating layer outside the base electrode; and
in the cross-section extending in the longitudinal direction and the stacking direction, the base electrode has, at the end portion in the stacking direction of the inner layer portion, a dimension L5 in the longitudinal direction, and, at the central portion in the stacking direction of the inner layer portion, a dimension L6 in the longitudinal direction; and
the dimension L6 is greater than the dimension L5.

17. The multilayer ceramic capacitor according to claim 4, wherein in the stacking direction, the outer-layer projection is located closer to the inner layer portion than each of the two major surfaces.

18. The multilayer ceramic capacitor according to claim 11, wherein
the outer-layer projection includes a maximum outer-layer projection where the outer-layer projection projects farthest in the longitudinal direction; and
a distance L4 from the inner layer portion to the maximum outer-layer projection is greater than or equal to about 1.50 μm and less than or equal to about 15.00 μm.

19. The multilayer ceramic capacitor according to claim 11, wherein
the outer electrode includes:
a base electrode on each of the two end surfaces; and
a plating layer outside the base electrode; and
in the cross-section extending in the longitudinal direction and the stacking direction, the base electrode has, at the end portion in the stacking direction of the inner layer portion, a dimension L5 in the longitudinal direction, and, at the central portion in the stacking direction of the inner layer portion, a dimension L6 in the longitudinal direction; and
the dimension L6 is greater than the dimension L5.

20. The multilayer ceramic capacitor according to claim 11, wherein in the stacking direction, the outer-layer projection is located closer to the inner layer portion than each of the two major surfaces.
